(19) United States
(12) Patent Application Publication
(10) Pub. No.: US 2017/0151108 A1
(43) Pub. Date: Jun. 1, 2017

(54) LOW-GEAR SYSTEM FOR MANUALLY PROPELLED WHEELCHAIRS AND METHODS OF USE

(71) Applicant: INTELLIWHEELS, INC., Champaign, IL (US)

(72) Inventors: Steven PICK, Champaign, IL (US); Scott DAIGLE, Champaign, IL (US)

(21) Appl. No.: 14/958,026

(22) Filed: Dec. 3, 2015

Related U.S. Application Data
(63) Continuation-in-part of application No. 13/631,088, filed on Sep. 28, 2012, now Pat. No. 9,301,892.
(60) Provisional application No. 61/540,768, filed on Sep. 29, 2011.

(51) Int. Cl. A61G 5/02; F16H 57/08

(52) U.S. Cl. CPC A61G 5/023; A61G 5/026; A61G 5/025; F16H 57/082

(57) ABSTRACT

A geared wheel system for minimizing backlash is functionally coupled to a wheelchair and disclosed herein.

### BACKGROUND

The invention generally relates to medical devices. In particular, this invention relates to manually propelled wheelchairs.

There are an estimated 1.5 million manual wheelchair users (mWCUs) in the United States, and an estimated 200 million wheelchair users worldwide. Manual wheelchair users depend on their upper limbs for mobility and activities of daily living. However, up to 70% of manual wheelchair users report shoulder pain. Shoulder pain in mWCUs has been directly linked to further disability including difficulty performing activities of daily living, decreased physical activity, and reduced quality of life. Overall, any loss of upper limb function due to pain adversely impacts the independence and mobility of mWCUs. Thus, it is imperative to provide innovative technologies, therapies, and interventions to minimize shoulder pain.

Additionally, some wheelchair users may already have diminished strength in their upper limbs. The magnitude of diminishment can make use of a traditional manual wheelchair, with the torque necessary to move up hills in particular, unduly difficult and impracticable. Thus, there is a need for a manual wheelchair to accommodate wheelchair users with diminished strength of their upper limbs.

Using a powered wheelchair takes away all strain on the shoulders and reduces shoulder pain. However, powered chairs are not a viable option for most wheelchair users, because they are expensive, heavy (i.e., too heavy to load into a car, requiring special vans and lifts), have limited use duration due to battery life, require frequent recharging, provide little flexibility for persons who are capable of manually propelling their own chair, are sometimes too wide to fit through doorways, and contribute to reduced physical fitness due to limited upper body movement. Additionally, there is often a negative stigma attached to the use of these devices among manual wheelchair users. Most manual wheelchair users would never utilize a powered wheelchair unless it was their last option.

In order to address this large segment of the community that experiences difficulty pushing a wheelchair, various designs have been provided in the art. Examples include power assist wheelchairs, lever operated wheelchairs, and manually gear shifting wheelchairs. Push-rim activated power assist wheelchairs (PAPAWs) were one of the first technologies that addressed this need. They are similar to power wheelchairs, but batteries and motors in the wheel hubs assist the user to push his/her chair. These devices have been shown to significantly reduce the amount of energy used by an mWCU. However, PAPAWs are not ideal since they are heavy (e.g., 53 lbs of added weight) and more difficult to maneuver than a manual wheelchair, as they require two large electric motors and a battery. Also, the range of such devices is limited before the battery needs recharged. Further, these devices are quite expensive, e.g., more than an entry level powered chair, and the price does not include the cost of a wheelchair frame.

Lever operated wheelchairs are an innovative way to utilize a more ergonomic rowing motion from the wheelchair user. An example lever operated wheelchair is provided in an add-on device from Wijit Wheelchairs (Roseville, Calif.). Evaluation of these devices has shown that levers are a more comfortable method of propulsion, and they reduce the amount of work from the shoulders. However, these devices do not follow the concept of a traditional wheelchair design; that is, use of hand rims. Such wheelchairs accordingly require a relatively high learning curve to switch between forward and reverse propulsion. With an unintuitive method for current manual wheelchair users of braking and pushing in reverse, these devices have been very slow to catch on.

Magic Wheels (Seattle, Wash.) created a two-speed wheelchair add-on system in which the second gear is specifically catered for going uphill. In a clinical trial using this device, subjects experienced a significant reduction in the severity of shoulder pain. However, a limitation is that the user has to stop and manually shift into the other gear, e.g., physically turn a dial on the side of the wheel to shift. For many wheelchair users who have limited dexterity in their hands (e.g., due to spinal cord injury), it is physically impossible to turn this dial. Further, users have to be cognizant of when to shift, and thus individuals with cognitive deficits such as traumatic brain injury, dementia, etc., are unable to utilize such a device.

There is a need in the art for a suitable device that fits in between manual and powered wheelchairs.

### SUMMARY OF THE INVENTION

Provided herein are methods, systems, and apparatuses for a geared wheel system for minimizing backlash comprising: a geared hub operably coupled to a hand rim support structure and a plurality of spokes; the hand rim support structure operably coupled to a wheel rim and the plurality of spokes operably connected to the wheels; and wherein the geared wheels are shifted from a direct drive transmission to a low gear drive transmission by a lever operably coupled on the outside of each hub.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a perspective view of a wheelchair apparatus.

FIG. 2A is one embodiment of the low gear drive system attached to the outside of a wheelchair wheel, with a planet retainer plate omitted for clarity.

FIG. 2B is an exploded view of the embodiment of FIG. 2A.

FIG. 3 is a perspective view of the embodiment of FIG. 2A depicting the planet carrier coupling to the wheel.

FIG. 4A is an assembled view of the mounting assembly.

FIG. 4B is an exploded view of the mounting assembly of FIG. 4A.

FIG. 4C is a cutaway view of the standard embodiment of the low gear drive system and the mounting assembly installed on a wheelchair.

FIG. 5A is a disassembled view of an embodiment of the invention further comprising a quick release mounting assembly.

FIG. 5B is an assembled view of the embodiment of the invention further comprising a quick release mounting assembly of FIG. 5A.

FIG. 5C is a cutaway view of an embodiment of the low gear drive system including ball bearings and quick release mounting assembly, installed on a wheelchair.

FIG. 6 is an exploded perspective view of one embodiment of the low gear drive system.

FIG. 7A is a perspective view of another embodiment of the low gear drive system.

FIG. 7B is an alternative perspective view of the embodiment of the low gear drive system depicted in FIG. 7A.

FIG. 8A is a perspective view of an alternative embodiment of the low gear drive system coupled with a manual wheelchair; and FIG. 8B is a perspective view of geared wheel.

FIG. 9A is a perspective view of one embodiment of the geared hub shown without the lever; FIG. 9B is a perspective view of one embodiment of the geared hub shown with the lever; and FIG. 9C is a perspective view of one embodiment of the geared hub shown with the lever.

FIG. 10A is a cross-sectional side view of one embodiment of the geared hub shown in low gear; FIG. 10B is a cross-sectional side view of one embodiment of the geared hub shown in neutral; FIG. 10C is a cross-sectional side view of one embodiment of the geared hub shown in direct drive.

FIG. 11A is a cross-sectional side view of one embodiment of the geared hub shown in high gear; FIG. 11B is a cross-sectional side view of one embodiment of the geared hub shown in neutral; and FIG. 11C is a cross-sectional side view of one embodiment of the geared hub shown in high gear.

FIG. 12 is cross-sectional side view of one embodiment of the geared hub in low gear that cannot be shifted.

FIG. 13 is a perspective view of the hand rim support structure.

FIG. 14 is a perspective cut-away view of the hand rim support structure.

FIG. 15A is a perspective view of one embodiment of the mounting system unengaged.

FIG. 15B is a perspective view of one embodiment of the mounting system engaged.

FIG. 16A is a perspective view of one embodiment of the mounting system unengaged.

FIG. 16B is a perspective view of one embodiment of the mounting system engaged.

FIG. 17A is a perspective view of the dog clutches unengaged; FIG. 17B is a perspective view of the dog clutches partially engaged; and FIG. 17C is a perspective view of the dog clutches fully engaged.

FIG. 18A is a cross-sectional side view of the shifting mechanism unengaged; and FIG. 18B is a cross-sectional side view of the shifting mechanism fully engaged.

FIG. 19A is a perspective view of the shifting mechanism in low gear; FIG. 19B is a perspective view of the shifting mechanism in neutral; and FIG. 19C is a perspective view of the shifting mechanism is direct drive.

### DETAILED DESCRIPTION OF THE INVENTION

The foregoing and other features and advantages of the invention are apparent from the following detailed description of some embodiments, read in conjunction with the accompanying drawings. The detailed description and drawings are merely illustrative of the invention rather than limiting, the scope of the invention being defined by the appended claims and equivalents thereof.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Generally speaking, the embodiments disclosed herein provide a single low-gear system for manually propelled wheelchairs. As opposed to standard manual wheelchairs having the hand rim directly attached to the wheel, the embodiments disclosed herein provide a single low-gear system where the hand rim turns the input of the low-gear system and the wheel is turned by the output of the low-gear system. In some embodiments, the input of the low-gear system may be coupled to any drive power source, such as a motor, a lever assembly, the hand rim, and/or the like.

In operation of a preferred embodiment, the wheelchair user still pushes the hand rims forward, backward, and in opposite directions in order to turn; however, the hand rims drive the low-gear systems (located near the hub of each wheel), which in turn drive the wheels. This reduces the amount of force required from the wheelchair user, which has the potential to reduce the severity and incidence of shoulder pain for mWCUs.

In contrast to motor driven wheelchairs in the art, example systems of the preferred embodiments disclosed herein do not have a range that is limited by battery life. Further, an example system weighs less than 10 lbs additional to the wheelchair. In contrast to lever operated wheelchairs, the preferred embodiments disclosed herein retain the standard hand rim method of controlling the wheelchair. The system provides for the operator of a traditional arm-powered wheelchair to make use of the wheelchair with little or no injury to the shoulder of the operator by reducing the force required to move the wheelchair. The input of the system is coupled to the hand rim, and the output is coupled to the wheel. Through use and configuration of gear systems, including planetary gear systems, the rotational velocity of the hand rim relative to the wheel can be increased or decreased, as the design provides. The system can include a ring gear, one or more sun gears, a planet carrier, one or more planet gears, and a mounting assembly for mounting the system to the wheelchair. The ring gear, sun gears, and planet carrier can be either fixedly attached or rotatably coupled to the axle of the system or the wheel or hand rim of the wheelchair to achieve the desired rotational ratio between the hand rim and the wheel.

A detailed description of the embodiments disclosed herein is provided in the following pages. It will be appreciated that these pages provide detail regarding the embodiments disclosed herein, and the invention is not limited to these embodiments or details. While embodiments disclosed herein are shown and described, it should be understood that other modifications, substitutions, and alternatives are apparent to one of ordinary skill in the art. Such modifications, substitutions, and alternatives can be made without departing from the spirit and scope of the invention.

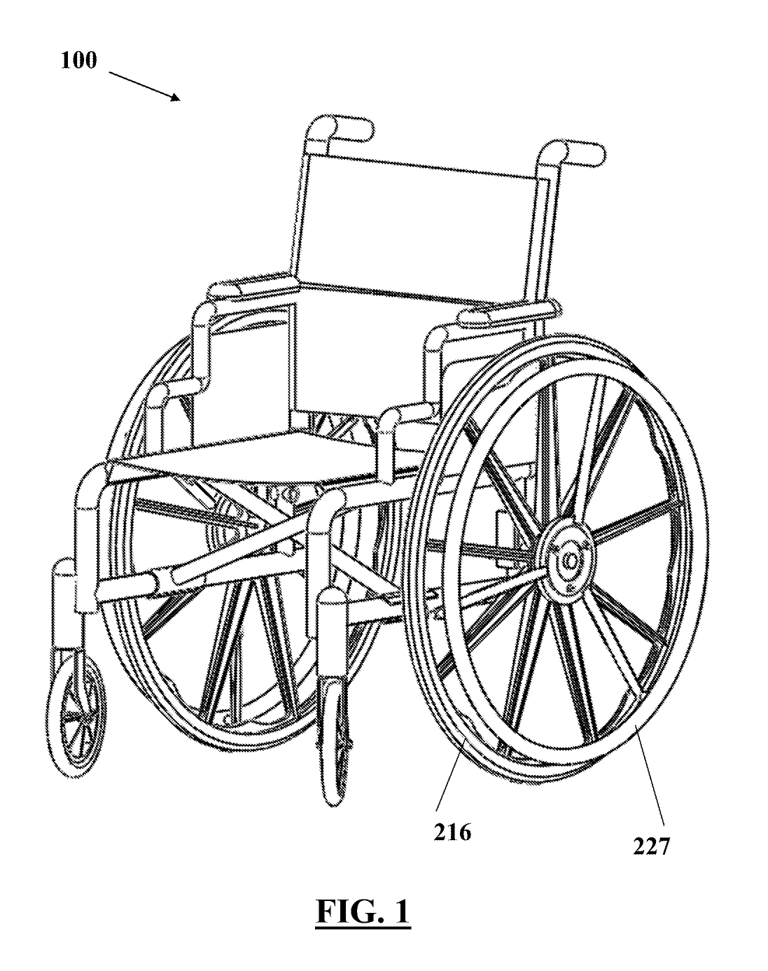

In one embodiment, the low-gear system is attached to the outside of each of the two wheels 216 of a wheelchair apparatus 100, as shown in FIG. 1. Alternatively, the low-gear system is attached to the inside of each of the two wheels 216 on the wheelchair 100. The output of the low-gear system is coupled to the wheel 216 and the input of the low-gear system is connected to the hand rims 227 as shown in FIG. 1. Alternatively, the input of the low-gear system may be connected to any manually powered device or apparatus coupled to the wheelchair, or any powered system if desired.

The embodiments disclosed herein include low-gear systems based on many different types of gear drive systems including, but not limited to, planetary gear sets, complex planetary gear sets, hypocycloidal gear sets, beveled gear sets, helical gear sets, traditional gear sets, and traditional gear sets in which multiple gears rotate on multiple axes of rotation.

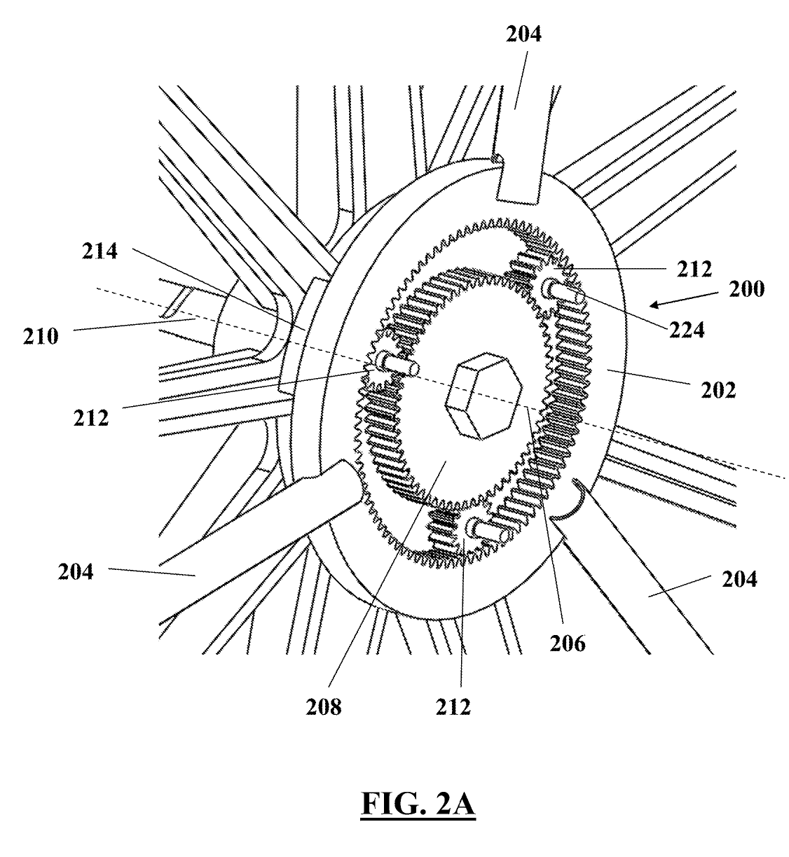

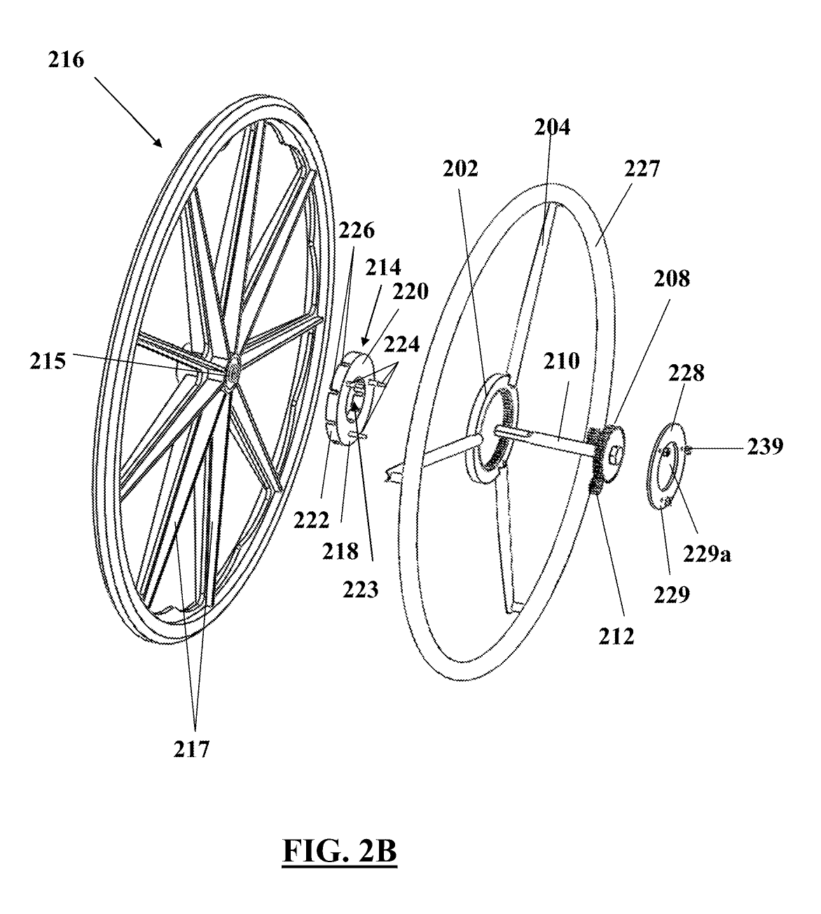

While all types of gearing systems are included in the embodiments disclosed herein, one preferred embodiment of a low-gear drive system is described in relation to FIGS. 2-4. FIG. 2A depicts an embodiment of the low-gear drive system, as shown coupled to a wheelchair in FIG. 1. The low-gear system 200 comprises a ring gear 202 fixedly attached to a hand rim 227 via a plurality of spokes 204. In one embodiment, the ring gear 202 is coaxially fixed to a center point or inner diameter of the hand rim 227. This embodiment does not limit the scope of the embodiments disclosed herein; any attachment method between the ring gear 202 and the hand rim 227 is included within the scope of the embodiments disclosed herein, such as a solid disk made from plastic, fiber glass, carbon fiber, or any other material. Preferably, the ring gear 202 is coaxially disposed within hand rim 227, and any force from the hand rim 227 is transmitted to the ring gear 202. In one embodiment, the ring gear 202 is coaxially attached to an inner diameter of the hand rim 227 by spokes 204. In one embodiment, the inner diameter of the hand rim 227 is between about 15 inches and 29 inches; alternatively, between about 19 and 25 inches; or alternatively, between about 20 and 23 inches. In one embodiment, the outer diameter of the ring gear 202 is between about 3 and 8 inches; alternatively, between about 4.0 and 6.0 inches; or alternatively, between about 4.5 and 5.0 inches. Thus, a ratio of the inner diameter of the hand rim 227 to the outer diameter of the ring gear 202 is at least between 2 and 10; alternatively, between at least 3.5 and 5.5; or alternatively, between at least 4.0 and 5.0. The ring gear 202 can define an axis of rotation 206 of the low-gear system 200. The low-gear system 200 can further comprise a sun gear 208. The sun gear 208 can define an axis of rotation that can be collinear to the axis of rotation 206 of the ring gear 202, when the sun gear 208 is coaxially disposed within the ring gear 202. The sun gear 208 can be fixedly attached to an axle 210, which coaxially extends from the inner surface of the sun gear 208.

The low-gear system 200 further comprises at least one planet gear 212 and a planet carrier 214. The planet gears 212 can constantly mesh with both the sun gear 208 and the ring gear 202. In the present embodiment, the low-gear system 200 comprises three planet gears 212; three or more planet gears 212 will maintain the collinearity of the axes of rotation of the ring gear 202 and the sun gear 208.

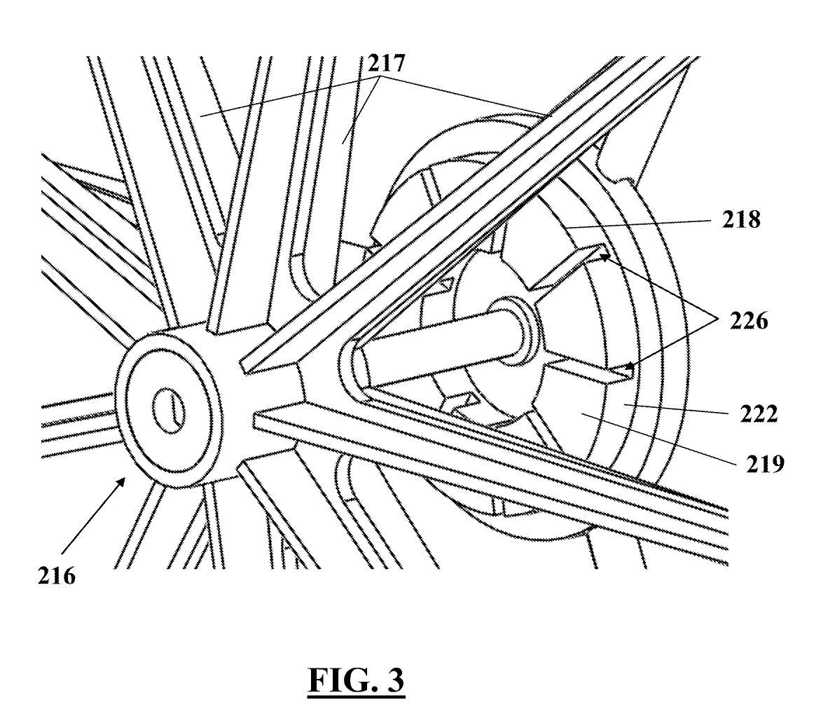

FIG. 2B depicts an exploded view of the embodiment of FIG. 2A. In the present embodiment, the planet carrier 214 is comprised of a body member 218 having a first surface 219 (as shown in FIG. 3), a second surface 220 opposite the first surface 219, and a wall thickness 222 therebetween. Furthermore, the body member 218 can be configured to define a void 223 through which the axle 210 can pass through. The void 223 may be of any shape and size, so long as it is sufficient to permit the axle 210 to pass therethrough. The planet carrier 214 has a diameter that is greater than the diameter of the sun gear 208, but is smaller than the diameter of the ring gear 202.

The planet carrier 214 further comprises one or more planet posts 224 projecting from the second surface 220 of the body member 218. Preferably, the planet posts 224 are integral with the body member 218. As shown in FIG. 2A, the planet gears 212 are rotatably coupled to the planet posts 224.

The planet carrier 214 can then be fixedly attached to the wheel 216. The method of attachment depends upon the structure of the wheel. The wheel 216 as depicted in FIG. 3 has a plurality of spokes 217, so one option is to form one or more slots 226 on the first surface 219 and into the wall thickness 222 of the body member 218, with each slot 226 adapted to receive and engage with one of the spokes 217. The slots 226 are disposed within the thickness of the first surface 219 and project radially from a concentric cup 226a disposed on the first surface 219. The concentric cup 226a coaxially fits over a wheel hub 215 on the wheel 216 when the slots 226 are fixedly associated with the spokes 217 of the wheel 216. When each slot 226 engages with its associated spoke 217, the planet carrier 214 will engage with the wheel 216 such that the planet carrier 214 cannot rotate with respect to the wheel 216. Accordingly, when the slots 226 operably engage with the spokes 217 of the wheel 216, as the planet carrier 214 is rotated, the wheel 216 and spokes 217 will also rotate.

Other methods for securing the planet carrier 214 to the wheel 216 are within the scope of the embodiments disclosed herein. Other methods include threaded couplings, keyed shafts, welding, set screws, nuts and/or bolts, any shape in which the two can engage with each other, and combining the wheel 216 and the planet carrier 214 as one integral part. These and any other method of securing the planet carrier 214 to the wheel 216 are included in the scope of the embodiments disclosed herein.

The low-gear system 200 can further comprise a planet retainer plate 228, as shown in FIG. 2B. The planet retainer plate 228 includes a plurality of holes 229 operably coupled to the planet posts 224, such that the planet gears 212 are positioned intermediate the second surface 220 of the body member 218 and the planet retainer plate 228, thereby preventing movement of the planet gears 212 along the length of the planet posts 224. The planet retainer plate 228 can be secured to the planet posts 224 by any suitable method, such as with nuts 239, rivets, or welding. Preferably, the planet retainer plate 228 includes a central opening 229a that fits over the sun gear 208.

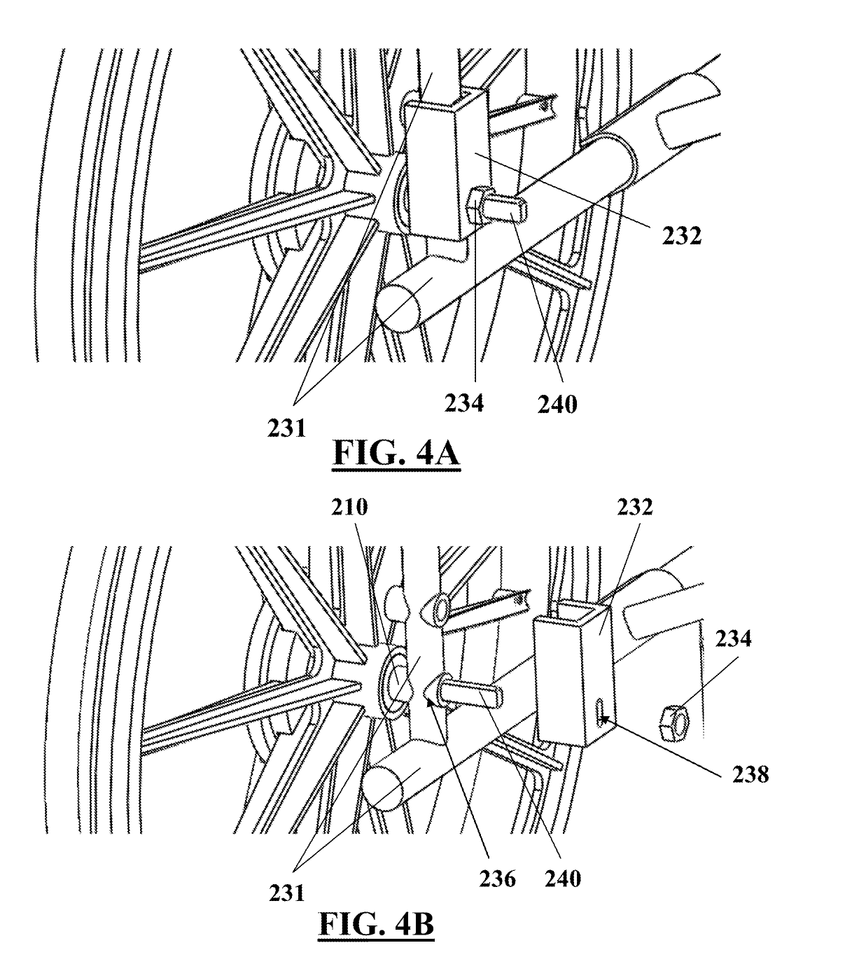

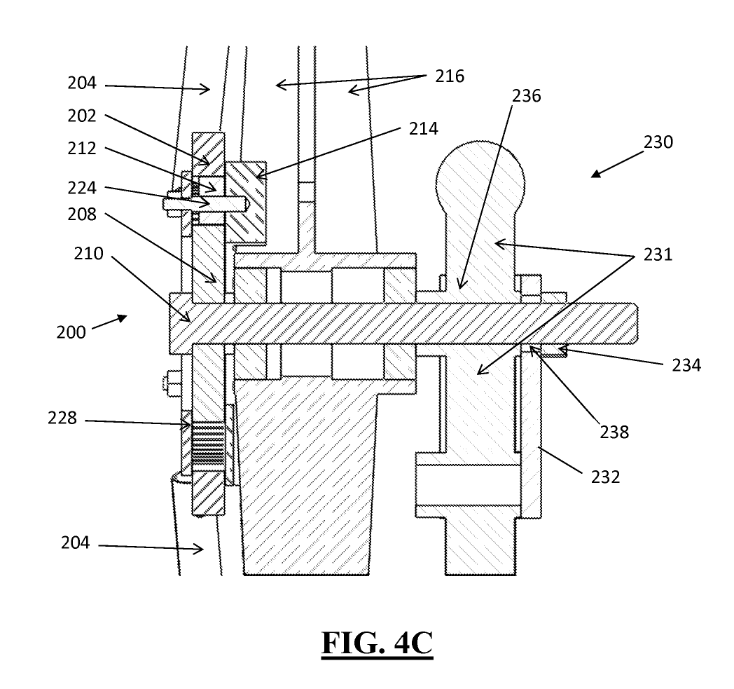

A view of the embodiment illustrated in FIGS. 2A, 2B, and 3 is shown coupled to the wheelchair body frame in FIGS. 4A-4C. The low-gear system 200 can further comprise a mounting assembly 230 to attach the low-gear system 200 to the frame 231 of the wheelchair. In the present embodiment, the mounting assembly 230 comprises a bracket 232 and a nut 234. To attach the low-gear system 200 to the frame 231, axle 210 can coaxially extend through a first axle aperture 236 in the frame 231, protruding on the opposite side of the first axle aperture 236. The bracket 232 can be configured to have a second axle aperture 238 through which axle 210 can coaxially extend. In order to prevent axle 210 from rotating, the axle 210 can include one or more ground flats 240. In the present embodiment, the second axle aperture 238 is configured to accommodate an axle with two ground flats, which, when passed therethrough, prevents rotation of the axle. The bracket 232 can further be configured to engage with the frame 231 of the wheelchair, as shown in FIGS. 4A-4C. Finally, the bracket 232 is secured to the frame by attaching a nut 234 to the ground flats 240 of the axle 210.

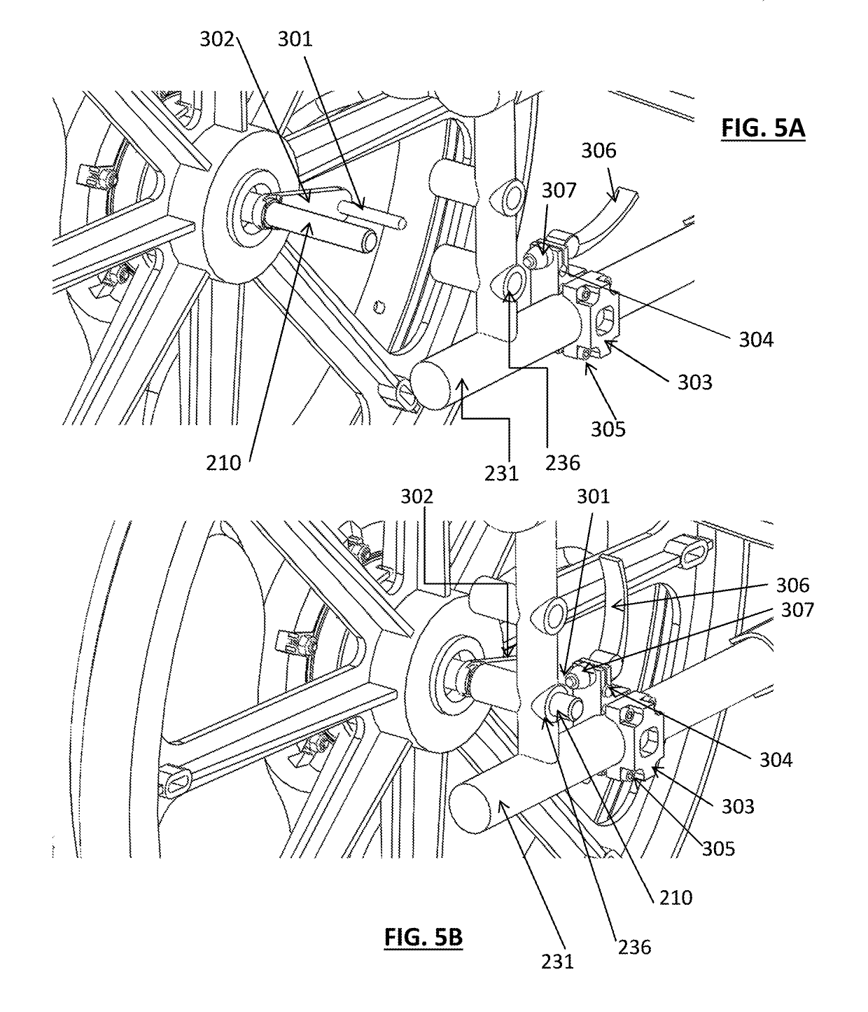

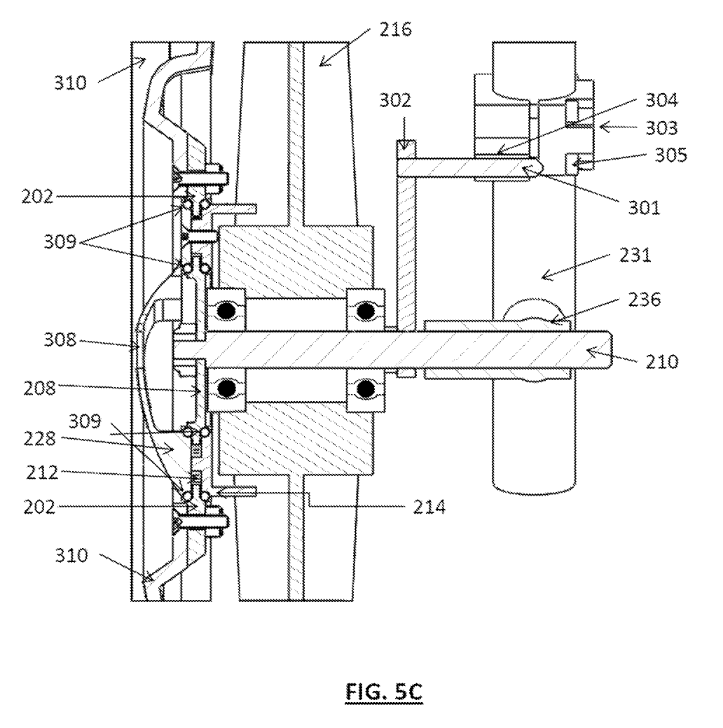

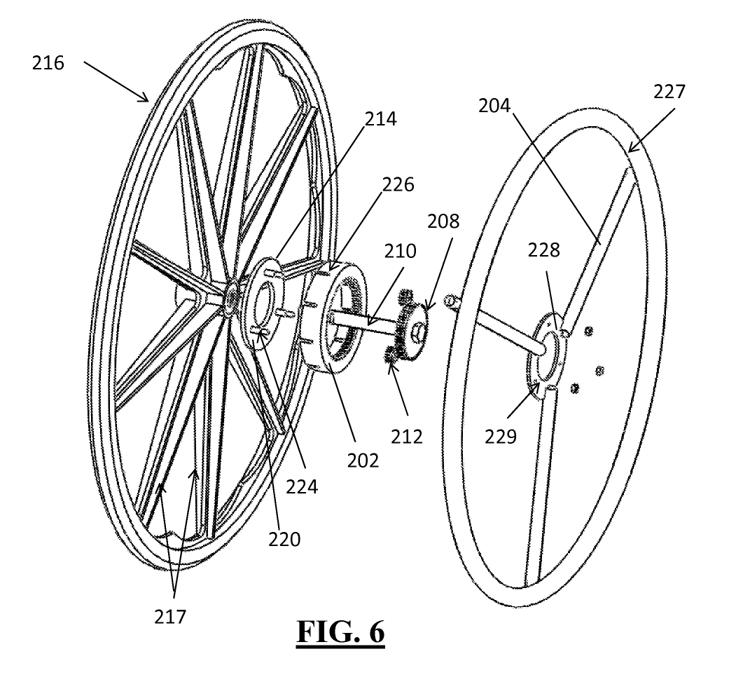

Other methods of preventing rotation of the axle 210 are within the scope of the embodiments disclosed herein, such as lock washers, a keyed shaft, shaft collars, welding the axle directly to the frame, or any other method. One such example of a method for preventing the axle from rotating is depicted in FIGS. 5A-5C. In this example embodiment, the axle 210 is a primary axle, and the primary axle 210 fits into the primary axle aperture 236 of the frame 231. This embodiment of the primary axle 210 has no ground flats, but it is fixedly attached to a secondary axle 301 with an axle plate 302 by welding, gluing, set screws, threaded couplings, keyed shafts or any other secure way of mounting such that the primary axle 210 cannot rotate in the axle plate 302. The secondary axle 301 then fits into a secondary axle aperture 304 of a quick release mounting assembly 303. In this embodiment, the quick release assembly 303 is attached to the frame 231 with four bolts 305. In alternative embodiments, the quick release assembly 303 may be attached to the frame 231 by welding, or the quick release assembly 303 may be integral with the frame 231. By inserting the secondary axle 301 into the secondary axle aperture 304, the primary axle 210 is prevented from rotating.

In this particular embodiment, the quick release assembly 303 also serves to allow the wheels 216 to be quickly attached or detached from the frame 231. By flipping the lever 306 of the binder bolt 307 to a down position as shown in FIG. 5A, the secondary axle aperture 304 widens allowing the secondary axle 301 to slide freely in or out. By flipping the lever 306 of the binder bolt 307 up as shown in FIG. 5B, the secondary axle aperture 304 contracts, which keeps the secondary axle 301 from sliding by friction, effectively rotatably attaching the entire wheel assembly to the frame 231 but fixably attaching the axles 210 and 301 to the frame 231. In this embodiment, the binder bolt 307 is mounted on the secondary axle aperture 304, but it could also be mounted on the primary axle aperture 236. Alternatively, the primary axle 210 could feature spring loaded ball bearings which protrude from the axle 210 to prevent it from sliding in and out of the primary axle aperture 236.

In order to provide easy handling, the planet retainer plate 228 can be shaped in a way that allows it to be grasped with a single hand. The planet retainer plate 228 therefore features a handle 308, as shown in FIG. 5C.

In order to decrease wear on the gear teeth, decrease gear noise, and increase the smoothness of operation, ball bearing tracks 309 can be formed into the sun gear 208, the planet retainer plate 228, the planet carrier 214, and the ring gear 202, as shown in FIG. 5C. The ball bearing tracks 309 allow ball bearings to roll in concentric circles about the primary axle 210, thus allowing smooth operation. Alternately, one could do without ball bearings and use a track made of a wear resistant material such as, but not limited to, nylon or acetal. In another embodiment, also shown in FIG. 5C, the plurality of spokes 204 may be replaced by a formed disk 310 which connects the ring gear 202 to the hand rim 227. The formed disk 310 has an additional benefit in that it prevents fingers from getting caught in the spokes. The formed disk 310 may be a solid disk made from plastic, fiber glass, carbon fiber, or any other material.

In operation, a user rotates the hand rim 227. The power imparted by the rotation will be transmitted through the plurality of spokes 204 or the formed disk 310 to the ring gear 202, causing the ring gear 202 to rotate. The rotation of the ring gear 202 will cause the planet gears 212 to rotate by the meshing engagement therebetween. Owing to the sun gear 208 being fixedly attached to the axle 210, the planet gears 212 will also rotate with respect to the axis of rotation 206. The rotation of the planet gears 212 about the axis of rotation 206 will rotate the planet carrier 214 as well as the wheel 216 to which the planet carrier 214 is engaged. By adjusting the sizes of the ring gear 202, the sun gear 208, the planet gears 212, and the planet carrier 214, the low-gear system will enable the hand rim 227 to rotate at a different angular velocity than the wheel 216. The low-gear system 200 can be configured to allow the hand rim 227 to rotate at an angular velocity greater or less than that of the wheel 216, whichever is desired for a given application.

With the embodiment previously described, the gear ratios that are possible include any ratio greater than 1:1 but less than 2:1. The ratio is changed by altering the size of the planet gears with respect to the size of the sun gear. As the size of the planet gear decreases, the gear ratio increases. If the ring gear is connected to the wheel and the planet carrier is attached to the hand rim, a high gear system is achieved where the gear ratios are exactly reversed. In this variation of the above embodiments, the gear ratios that are possible include any gear ratio greater than 1:2 but less than 1:1.

In an alternative embodiment, the planet carrier 214 is fixedly attached to the hand rim 227 and the ring gear 202 is fixedly attached to the wheel 216, as shown in FIG. 6. The planet carrier 214 may be attached to the hand rim 227 by any method of attachment to the hand rim 227 described hereinabove. In one embodiment, the planet retainer plate 228 is coaxially fixed to the hand rim 227 by way of a plurality of spokes 204, and in another embodiment it is attached with a formed disk 310. As indicated above, the plate retainer plate 228 may be coaxially fixed to a center point or inner diameter of the hand rim 227. The planet retainer plate 228 includes the plurality of holes 229 through which the planet posts 224 coaxially fit, thereby fixedly attaching the planet carrier 214 to the hand rim 227. Similarly, the ring gear 202 may be fixedly attached to the wheel 216 by any method of attachment to the wheel 216 described hereinabove. In one embodiment, the ring gear 202 includes one or more slots 226 on the first surface 219 that are disposed within a wall thickness of the ring gear 202, with each slot 226 adapted to receive and engage with one of the spokes 217 of the wheel 216. In a similar fashion, the sun gear 208 is coaxially disposed within the ring gear 202 and rotatably associated with the at least one planet gear 212. The at least one planet gear 212 is rotatably associated with the planet posts 224 and the ring gear 202 as to transmit rotation of the hand rim 227 and planet retainer plate 228 to the ring gear 202 and the wheel 216. The sun gear 208 can be fixedly attached to an axle 210, which coaxially extends from the inner surface of the sun gear 208. In some embodiments, the relative positions of the ring gear 202 and the planet carrier 214 may be reversed to permit the attachment of the ring gear 202 to the wheel 216, if the method of attachment so requires.

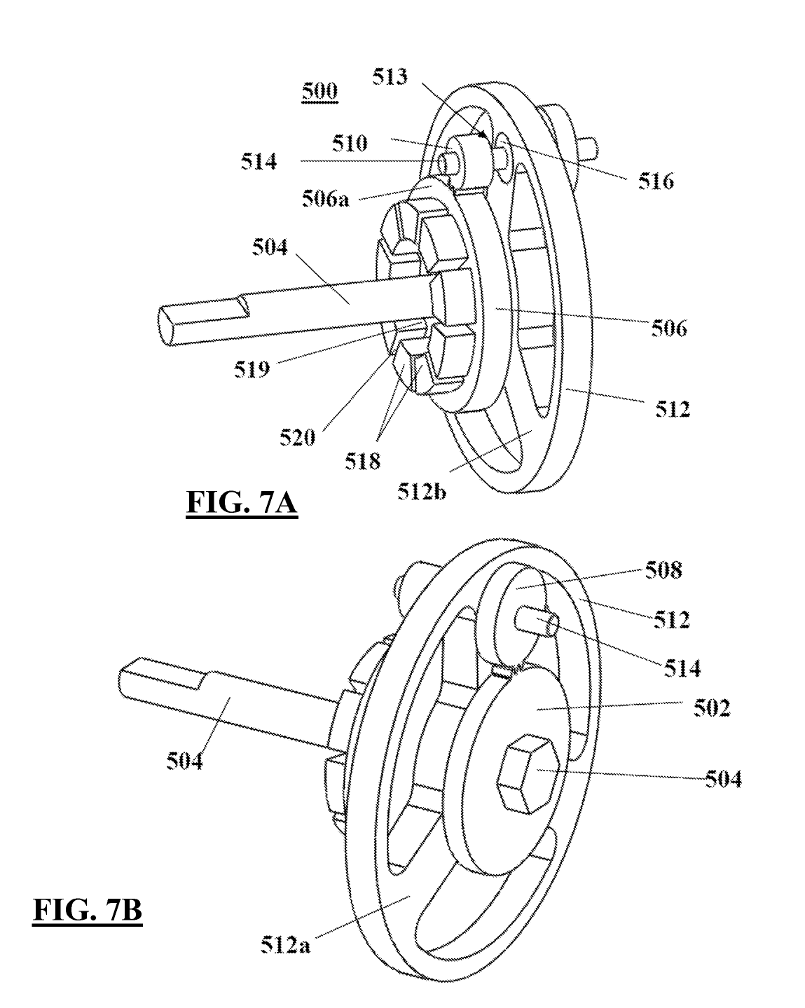

A further embodiment of the invention disclosed herein is depicted in FIGS. 7A-B. Here, the low-gear system 500 comprises a first sun gear 502 fixedly attached to an axle 504 and a second sun gear 506 fixedly associated to the axle 504. The low-gear system 500 further comprises a first planet gear 508 and a second planet gear 510, wherein the first and second planet gears 508, 510 are rotatably coupled to a planet carrier 512. The first planet gear 508 can be functionally coupled to the second planet gear 510 such that rotation of one causes a corresponding rotation of the other. Furthermore, the first planet gear 508 can be meshed with the first sun gear 502 and the second planet gear 510 can be meshed with the second sun gear 506.

The planet carrier 512 includes a first surface 512a and a second surface 512b, whereby the first sun gear 502 is rotatably associated with the first surface 512a and the second sun gear 506 is rotatably associated with the second surface 506. The first planet gear 508 is rotatably coupled to the first surface 512a of the planet carrier 512 and the second planet gear 510 can be rotatably coupled to the second surface 512b of the planet carrier 512. In the present embodiment, the first planet gear 508 and the second planet gear 510 are coupled via a planet attachment assembly 513 comprising a planet post 514 and a ball bearing 516. The first planet gear 508 and the second planet gear 510 can be rotatably attached to the planet post 514 by any suitable method, including welding, keys, ground flats, set screws, and any other method known in the art. In order to accommodate the ball bearing 516, the planet carrier 512 can include an aperture configured to allow the ball bearing 516 to be disposed therein. The ball bearing 516 can be fixedly attached to the planet carrier 512 by any suitable method, such as by welding or press fit. The planet post 514 can then be attached to the ball bearing 516 such that the planet post 514, and by extension the first planet gear 508 and the second planet gear 510, can rotate with respect to the planet carrier 512.

The second sun gear 506 can be fixedly attached to the wheel by any method of attachment described hereinabove for attachment to the wheel 216. For example, second sun gear 506 can comprise a plurality of protrusions 518 projecting from a surface 506a of the second sun gear 506. The plurality of protrusions 518 can radially extend around a central cup 519 and the protrusions 518 can be configured to form a plurality of slots 520 intermediate each of the protrusions 518. Similar to the method of attachment of the planet carrier 214 to the wheel 216 above, the plurality of slots 520 can be configured to be associated and fixedly engage with the spokes 217 of the wheel 216 (not pictured) so as to prevent the second sun gear 506 from rotating with respect to the wheel 216. Accordingly, rotation of the second sun gear 506 cases rotation of the spokes 217 of the wheel 216. Similarly, the planet carrier 512 can be fixedly attached to the spokes 204 of the hand rim 227 by any method described hereinabove for attachment to the wheel 216. Alternatively, the planet carrier 512 is coaxially fixed within an inner diameter of the hand rim 227 by means of a formed disk 310 or a plurality of spokes 204.

In an alternative embodiment, the planet carrier 512 can be fixedly attached to the wheel 216, while the first sun gear 502 and the second sun gear 506 can be fixedly attached to the hand rim 227. The first sun gear 502 and second sun gear 506 can be fixedly attached to the hand rim 227 by any of the methods described hereinabove, and the planet carrier 512 can be attached to the wheel 216 by any of the methods described hereinabove.

In further alternative embodiments, the planet carrier 512, the first sun gear 502, the second sun gear 506, and the pairs of first and second planet gears 508, 510 can be positioned in any order along the length of the axle 210. This includes configurations in which the first sun gear 502, the second sun gear, 506, and the pairs of first and second planet gears 508, 510 are on one side of the planet carrier 512.

Minimizing Backlash

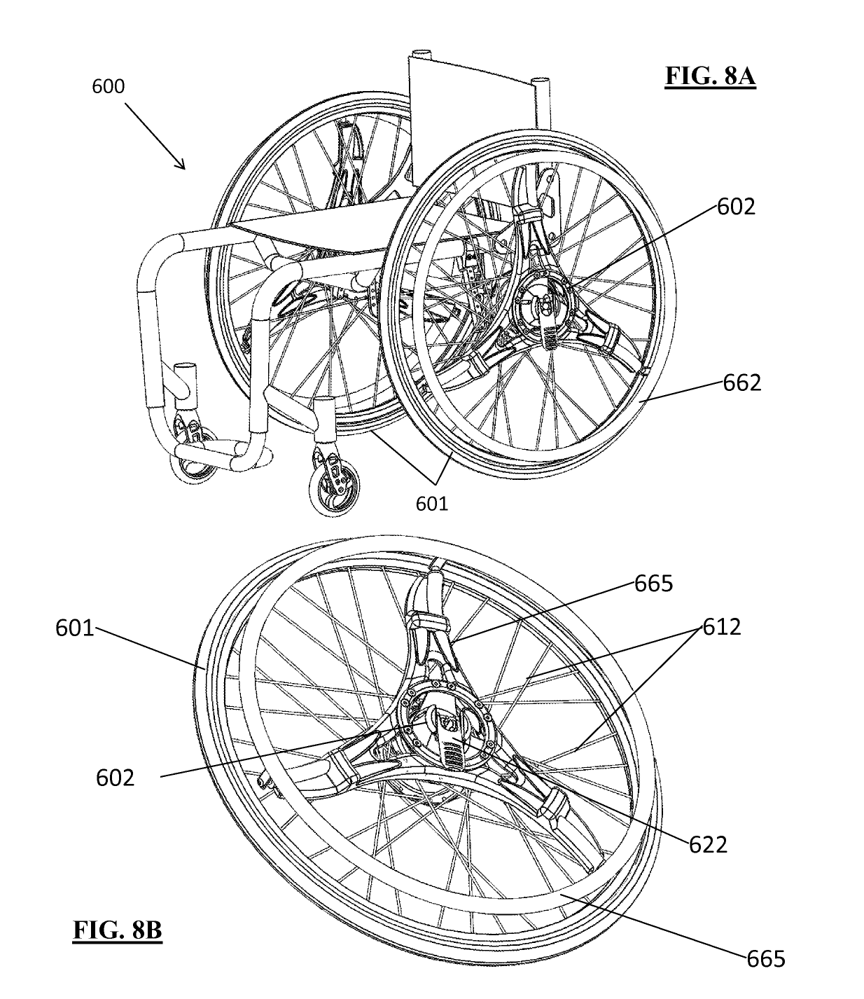

As shown in FIGS. 8A-8B, an alternative embodiment of the low gear drive system is a set of geared wheels 601 for manual wheelchairs 600 that are optimized to be the lightest weight possible and have minimal backlash in the drive train. Backlash can be described as the amount of slop felt in the drive train when pushing forwards and backwards. Backlash, sometimes called lash or play, is clearance or lost motion in a mechanism caused by gaps between the parts. Backlash can be defined as the maximum distance or angle through which any part of a mechanical system may be moved in one direction without applying appreciable force or motion to the next part in mechanical sequence, and is a mechanical form of deadband. An example, in the context of gears and gear trains, is the amount of clearance between mated gear teeth. It can be seen when the direction of movement is reversed and the slack or lost motion is taken up before the reversal of motion is complete. Minimal backlash is especially important in wheelchairs because the hand rims are used for propulsion forwards, propulsion backwards, braking forwards, and braking backwards. Surplus backlash in the design results in a perception of lower quality by the users. Also, previous geared wheels have been quite heavy which causes extra exertion from the user as to contribute to backlash. By making each component as small as possible while maintaining mechanical reliability, this design achieves the lightweight design and minimizing backlash.

As shown in FIGS. 8A-8B, the geared wheels 601 include a geared hub 602 operably coupled to a hand rim support structure 665 and a plurality of spokes 612. The hand rim support structure 665 is operably coupled to a wheel rim 662 and the plurality of spokes 612 connected to the wheels 601. The geared wheels 601 can be shifted from direct drive to a low gear by an ergonomic lever 622 operably coupled on the outside of each hub 602. The lever 622 is shaped such that those with low hand dexterity can easily grab on to it and shift it into the next gear. In one embodiment, the shape of the lever 622 is a large flat lever that can be rotated at least 140 degrees. By changing the geometry of different parts, the lever 622 may be rotated from about 0.1 to about 360 degrees. As the lever 622 rotates, it moves the shifting components linearly as further described below.

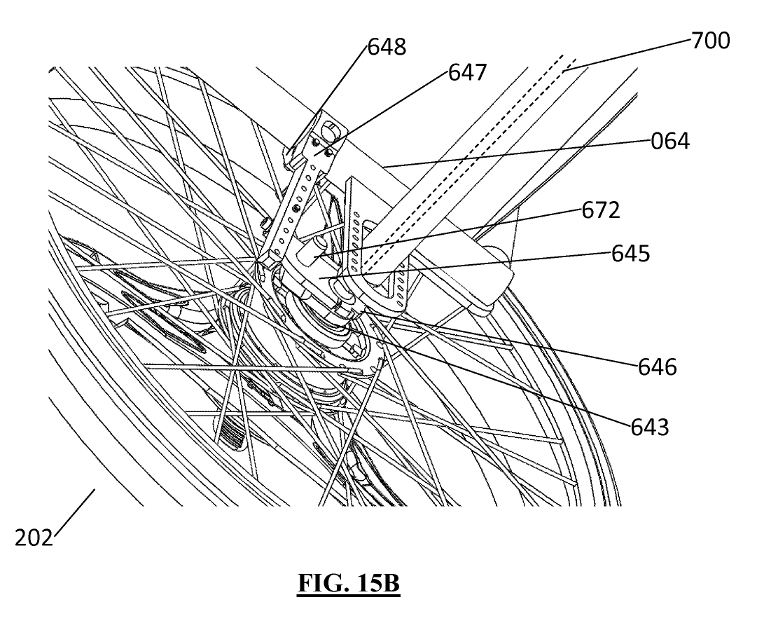

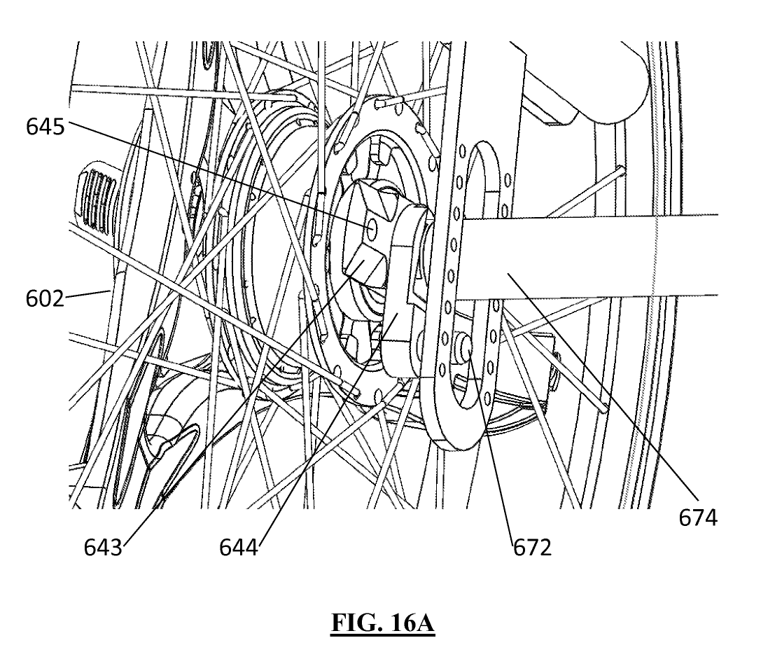

The geared wheels 601 mount to the wheelchair 600 with a quick release axle 700 operably coupled with a custom mounting system 631, as shown in FIGS. 15A-15B. This custom mounting system 631 allows the wheelchair user to mount the wheels 601 as easily as if they were non-geared wheels. Previous geared wheel mounting designs require the user to line up a secondary axle by rotating the wheel. This custom mounting system 631 does not require the user to line a secondary axle by rotating the wheel 601.

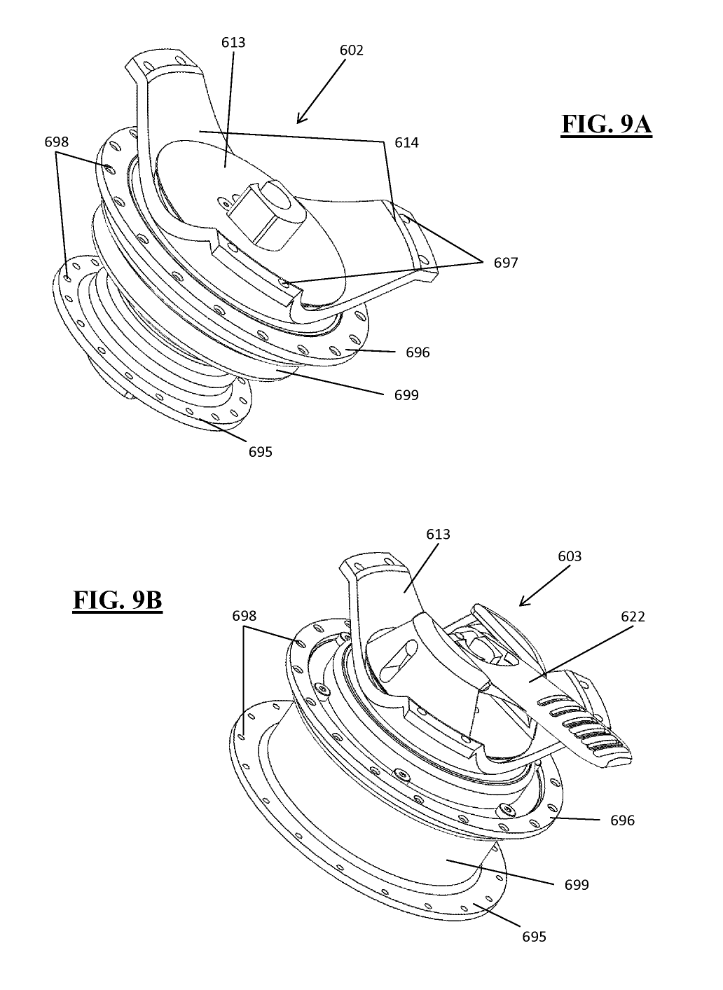

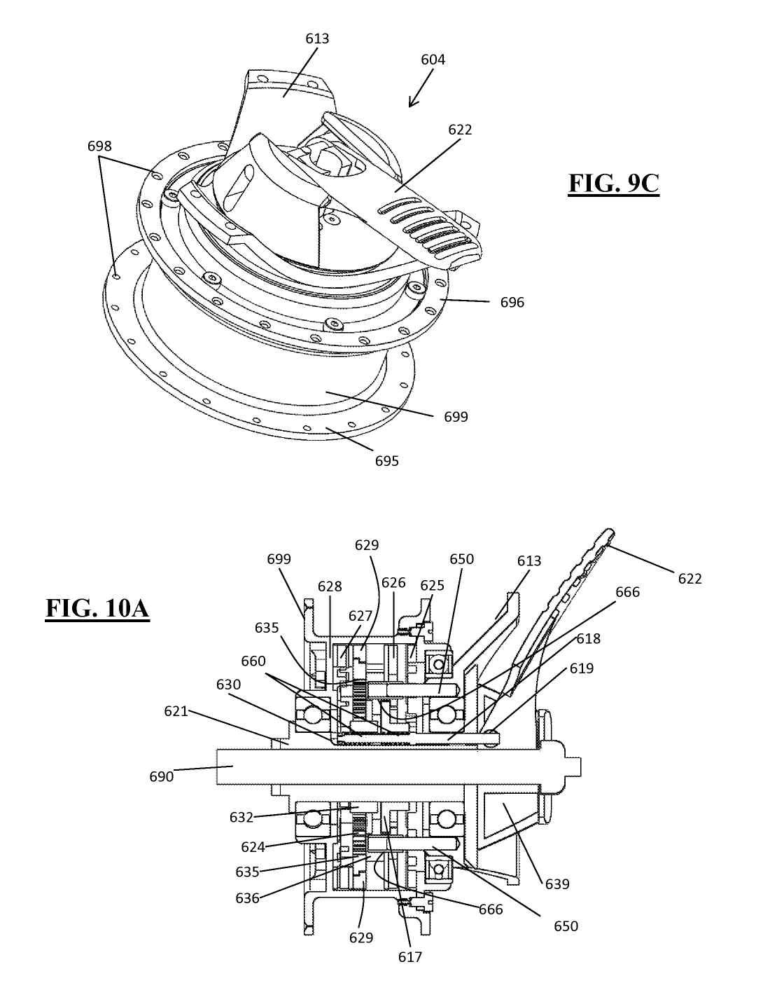

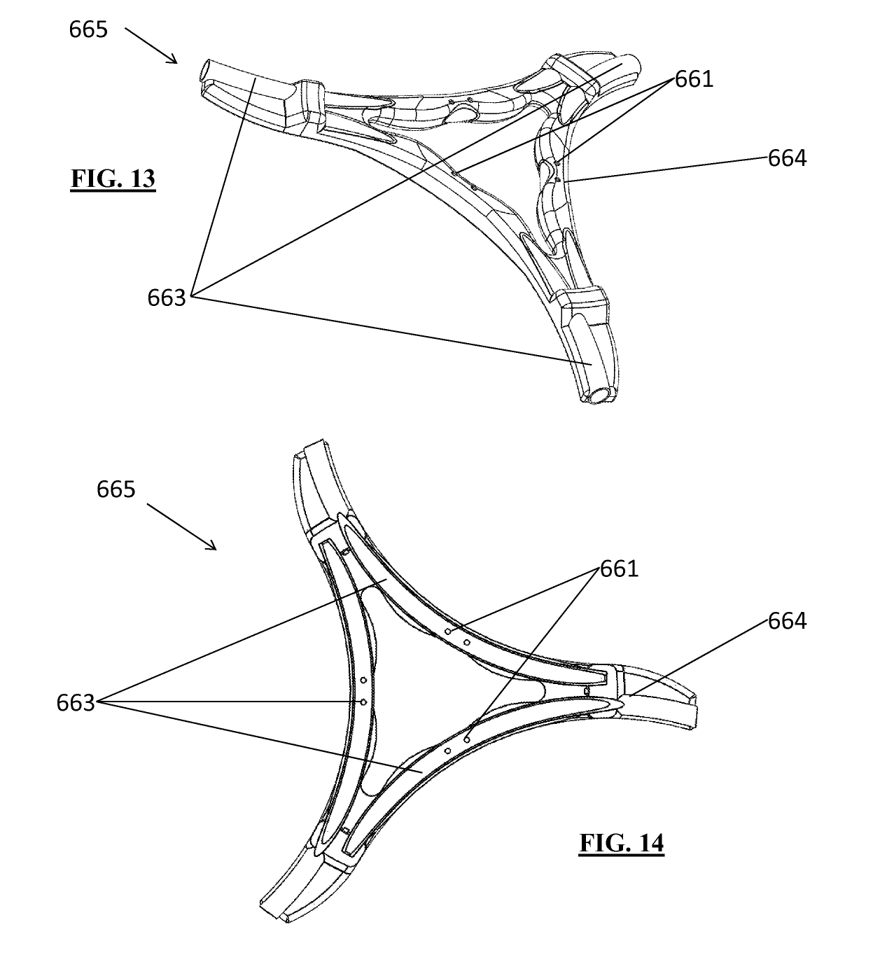

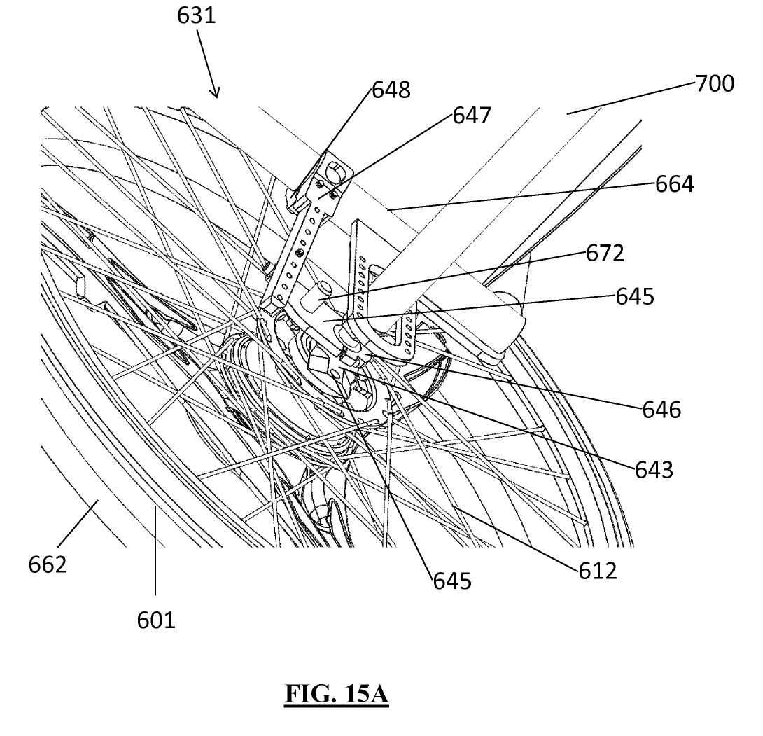

In one embodiment, the gearing is completely encased in a metal geared hub 602, as shown in FIG. 9A. Alternative metal geared hubs 603 and 604 are shown in FIGS. 9B-9C. The metal geared hub 602 includes a hub shell 699. The hub shell 699 includes a first outer axial ring 696 and a second outer axial ring 695. The first and second outer axial rings 696, 695 include a plurality of holes 698 disposed around the circumference of the first and second outer axial rings 696, 695. The plurality of holes 698 are connected to the spokes 612, which are connected to the wheel rim 662. The geared hub 602 includes an input disk 613 disposed axially over the first outer axial ring 696. The input disk 613 includes a plurality of flanges 614 of the disposed around the circumference of the input disk 613. In one embodiment, there are three flanges 614 disposed the circumference of the input disk 613, in alternative embodiments, there may be between two and 6 flanges 614. The distal ends of the flanges 614 axially flare out from the central axis of the input disk 613 and the distal ends of the flanges 614 include a plurality of openings 697 as to be fixedly attached a hand rim support structure 665, as shown in FIGS. 13-14. Shifting is accomplished via an ergonomic lever 622 on the outside of the hub 602. The hub shell 699 is the output of the transmission, and the input disk 613 is the input of the transmission.

Hand Rim Support Structure

The hand rim support structure 665, shown in FIGS. 13-14, is an integral part of the geared wheel design. The hand rim support structure 665 transmits torque and rotation from the hand rim 662 to the input disk 613 of the geared hubs 602, 603, 604. The hand rim support structure 665 is very light and very rigid. In one embodiment, the hand rim support structure is between is about 0.50 and about 2.50 lbs. If the hand rim support structure 665 is not rigid, the wheelchair user will feel the hand rim flex in and out while pushing. To achieve the stiffest and lightest weight system possible, the hand rim support structure 665 comprises a two-part system.

The hand rim support structure 665 comprises a plurality of radially extending hollow tubes 663 operably coupled with a molding 664. In one embodiment, the radially extending hollow tubes 663 are composed of extruded aluminum. In other embodiment, other lightweight metals or plastics may be used, such as die cast aluminum or magnesium. The molding 664 surrounds the plurality of radially extending hollow tubes 663, which bonds with the tubes 663 into the correct shape. In one embodiment, the molding 664 is a plastic molding, urethane, or a glass filled nylon. In one embodiment, the plastic molding is a minimum of 0.10 inch in thickness around the aluminum tubes, and there are relatively large thickness of plastic molding where the ends of the tubes 663 meet, with the purpose of increasing strength and increasing rigidity. In one embodiment, the shape of the tubes 663 is substantially curved. In one embodiment, the tubes 663 are curved with angle between about 10 and 85 degrees, alternatively, about 20 degrees. The middle portions of the tubes 663 and the molding 664 may include at least two openings 661 that permit the structure 665 to be fixedly attached to the input disk 613. In one embodiment, the number of tubes 663 is the same as the number of flanges 613 on the input disk 613. In one embodiment, the number of tubes 663 may be between about two and six.

Shift Lever

Many people with spinal cord injuries have limited hand dexterity. In order to shift gears effectively, the shifter must be easy to articulate without too much fine motor control. For this reason, the lever 622 includes a large flat section, as shown in FIG. 9C, that can be pressed comfortably with the palm of the hand, or pulled to the next position with the tips of the fingers. Neither motion requires grasping.

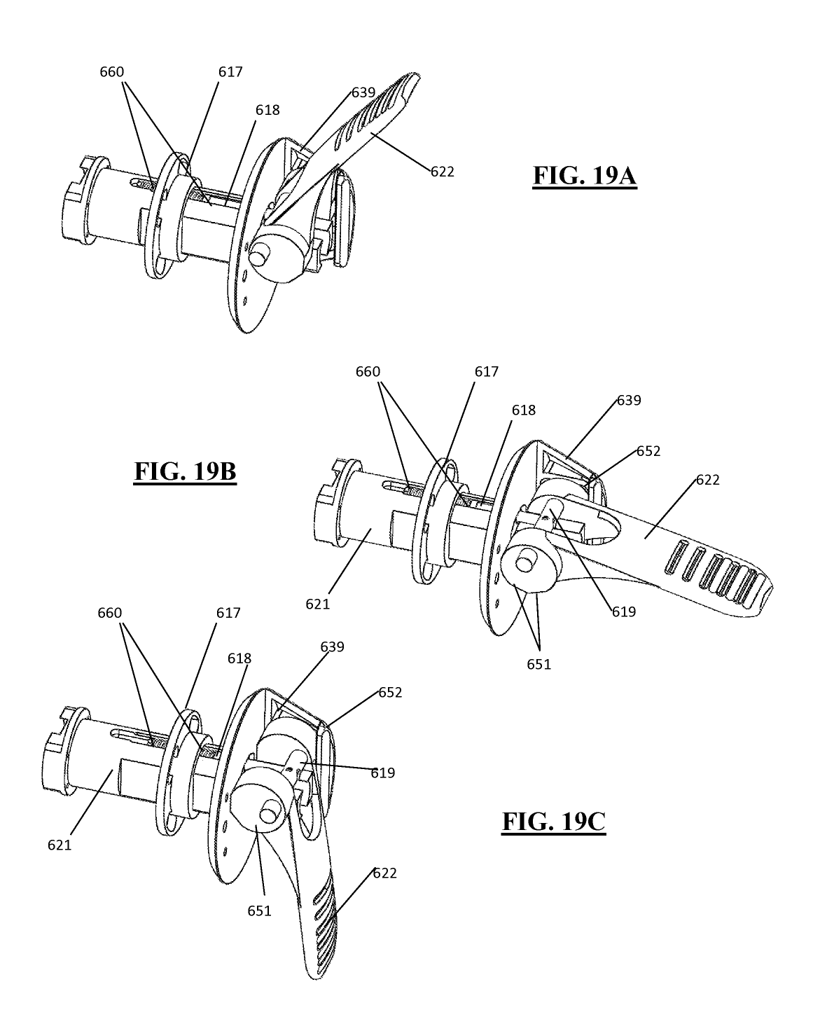

The lever 622 rotates in a track 639 and includes at least two flats 651, as shown in FIGS. 19A-19C. The two flats 651 serve as mechanical detents to hold the lever 622 in low gear or high gear. The lever 622 includes at least two track features 639 and a secondary slot 652 which lines up with a rod 619 that extends through the round portion of the shift lever 622. The combination of the secondary slot and the track transmits the rotational motion of the shift lever 622 into linear motion of the shift rod 618. The shifter rod 618 is described further below.

Shifter Carriage Design

In one embodiment, the geared hub includes a planetary gear set. The planetary gear set is part of a shifter carriage 630 to allow the gear box to move between gears. The shifter carriage 630 comprises gear carrier 636, the ring gear 635, a first dog clutch 626 connected to the gear carrier 636, a second dog clutch 627 which carries the four planet gears 624, and two gear keepers 629 which link the ring gear 635 to the dog clutch while allowing independent rotation. 4 bushings 666 are attached to the gear carrier 636 through the first dog clutch 626. A sun gear 632 is not part of the shifter carriage. The sun gear 632 is always locked to the axle sleeve 621, and does not move axially or rotate.

The shifter carriage 630 rides axially along 4 dowel pins 650 extending from the input disk 613. The dowel pins 650 provide minimal backlash in the rotational direction while allowing the carriage 630 to move axially inside the hub. The bushings 666 are reamed out to a size slightly larger than the dowel pins 650 in order to minimize backlash while still allowing smooth movement. In one embodiment this corresponded to 0.1875″ DIA dowel pins 650 and 0.196″ inner DIA bushings 666. The dowel pins 650 and the bushings 666 that surround them have the added advantage that they are very resistant to mechanical wear which keeps the amount of backlash from increasing significantly over the life of the gearbox.

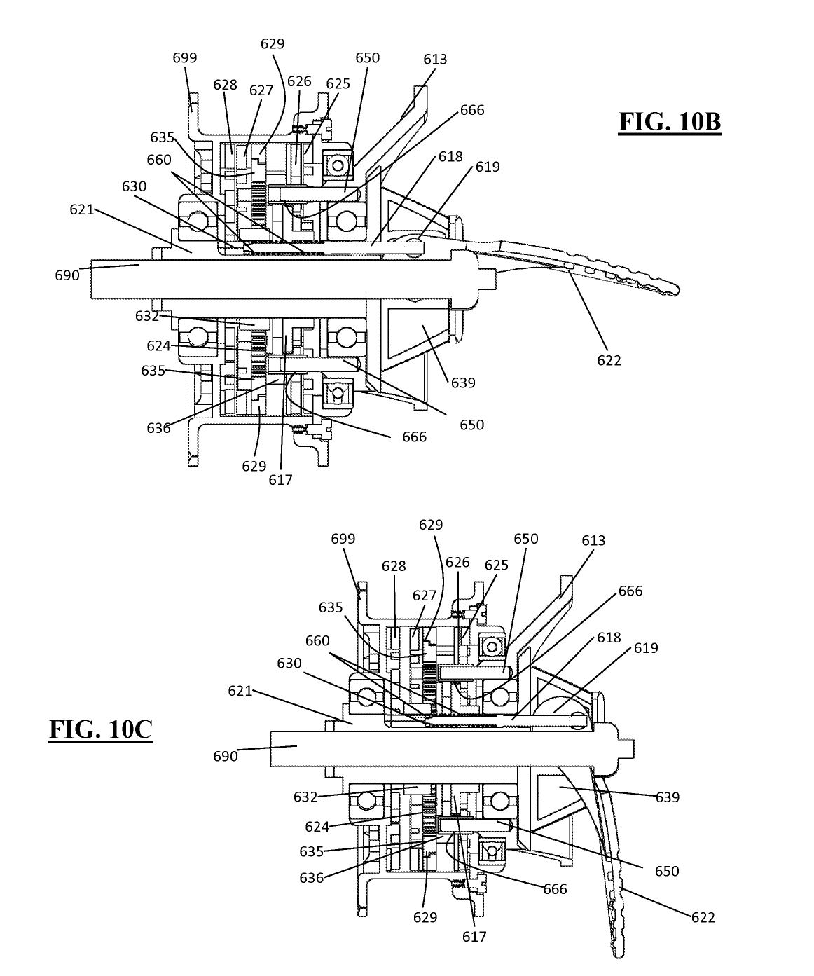

When the shifter carriage 230 moves from FIG. 10B to the position of FIG. 10C, the first dog clutch 626 connected to the gear carrier 636 engages with a third dog clutch 625 connected to the hub shell 699. This makes the flow of torque go from the input disk 613, into the dowel pins 650, into the gear carrier 636, into the first and third dog clutches 626, 625, and out through the hub shell 699 at a 1:1 gear ratio.

When the shifter carriage 230 moves from FIG. 10B to the position of FIG. 10A, the second dog clutch 627 on the left of the shifter carriage 630 engages with a fourth dog clutch 628 that is connected to the hub shell 699. This makes the flow of torque go from the input disk 613, into the dowel pins 650, into the gear carrier 636, into the second dog clutch 627 at 1.5:1 gear ratio, into the fourth dog clutch 628, and out through the hub shell 699.

When the shifter carriage 630 is in position of FIG. 10B, no dog clutches are engaged, which keeps the geared hub 603 in neutral. Neutral may be of no use to the user, but it is required for proper functioning of the geared wheel or other functions such as towing.

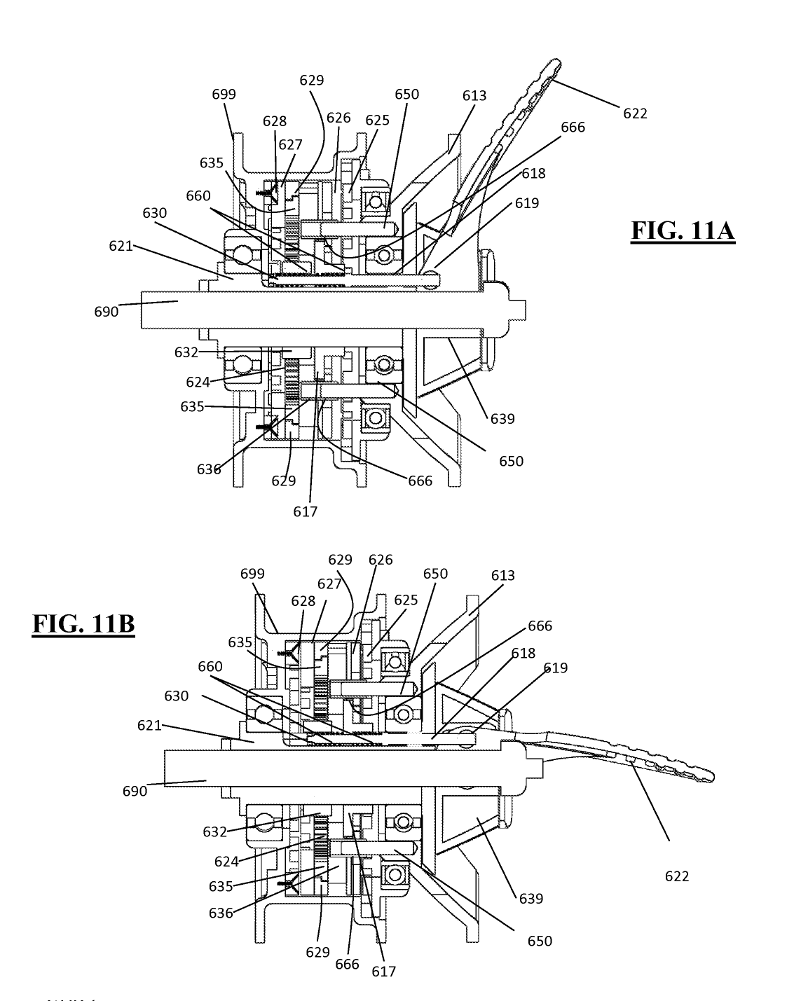

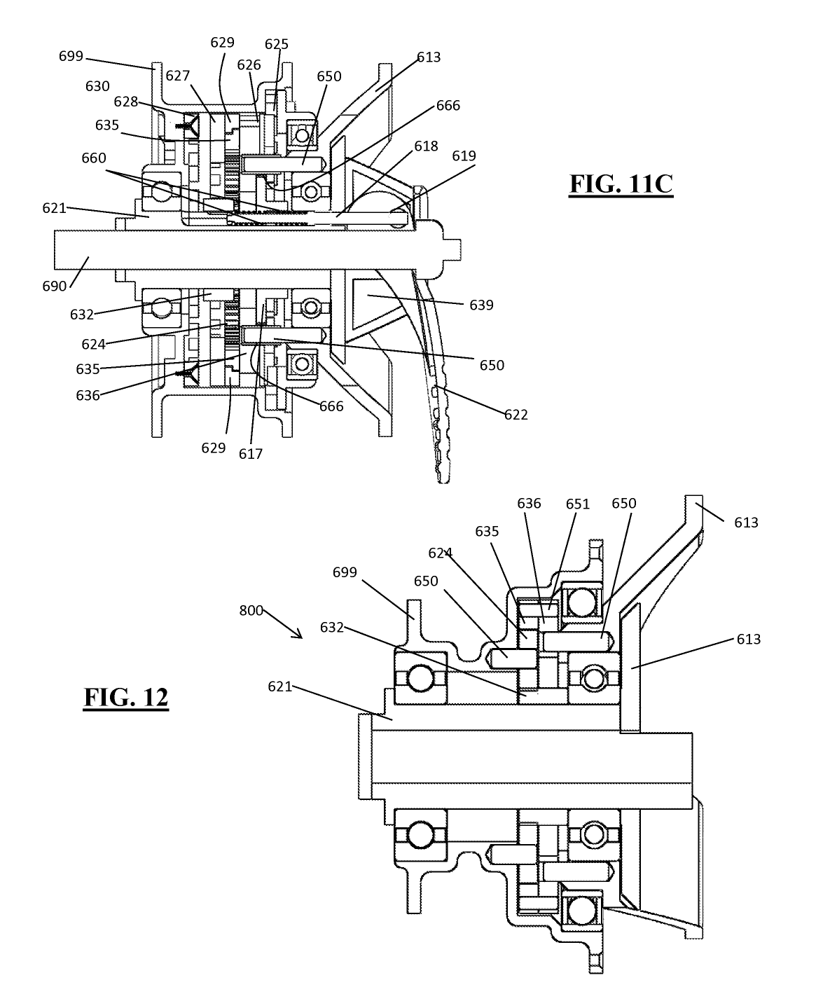

An alternate embodiment is shown in FIG. 11A-11C, the planet gears 624 are connected to the gear carrier 636 rather than the second dog clutch 627, and locks the ring gear 635 rotationally to the second dog clutch 627 rather than the gear carrier 636. This reverses the gear ratio so that the geared hub 204 can be in direct drive 1:1 or high gear 1:1.5 gear ratio.

An alternate embodiment shown in FIG. 12 shows an alternative geared hub 800. This geared hub 800 is always in low gear and cannot be shifted. In this embodiment, torque flows from the input disk 613, into the gear carrier 636, into the ring gear 635. The ring gear 635 turns the planet gears 624 at a 1.5:1 ratio thanks to the sun gear 632 which is locked to the axle sleeve 621. The planet gears are on dowel pins 650 and 651 pressed into the hub shell 699, so the hub shell 699 is effectively turned at a 1.5:1 ratio from the input disk 613.

Dog Clutch Design

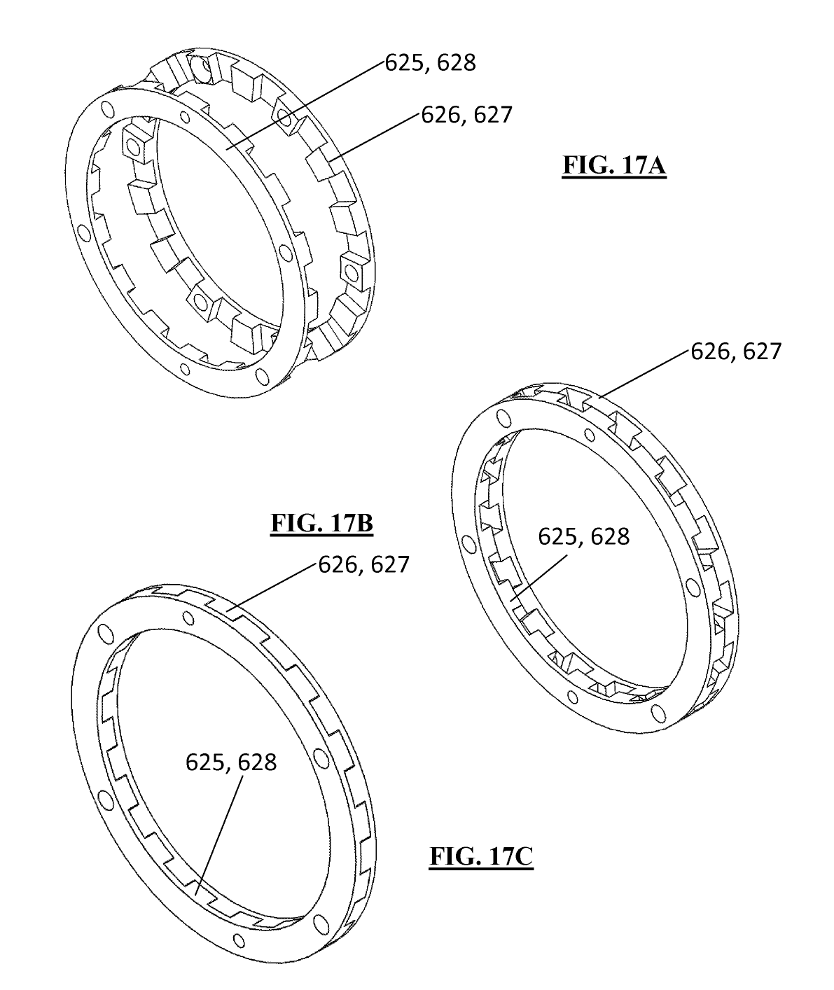

The purpose of the dog clutches 625, 626, 627, 628 is to engage a gear with minimal backlash, in a small package, and at a minimal weight. FIGS. 17A-17C shows them in perspective view. A traditional clutch would have zero backlash, but it would be far too large and heavy to be useful in a wheelchair. The dog clutch requires no force to keep it engaged, and can be designed in a small compact space. A dog clutch is a type of clutch that couples two rotating components not by friction but by interference. The two parts of the clutch are designed such that one will push the other, causing both to rotate at the same speed and will never slip.

In one embodiment, the dog clutches are made from hardened steel for optimal wear resistance, and have minimal clearance between the teeth. The clearance is between about 0.002″ and 0.015″. In another embodiment, the dog clutches include teeth comprising 0, 0.5, 1, and 2 degree gaps between each tooth and corresponding slot. In one embodiment, a 0.5 degree gap is selected for easy engagement and low backlash. A 0.5 degree gap corresponds to 0.0153 inch clearance when measured at a diameter of 3.5 inches and that provides a positive tolerance you get a clearance range of about 0.015 inches and about 0.002 inches.

Shifter Rod Design

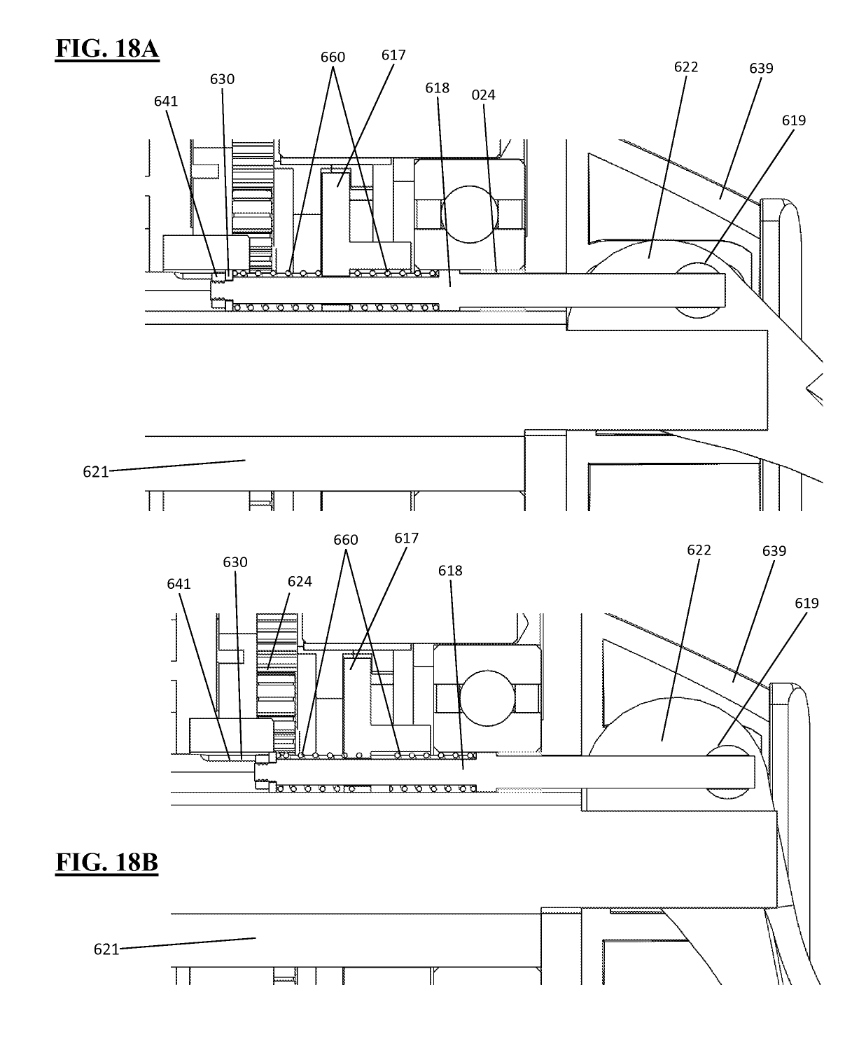

As shown in FIGS. 18-19, the shifter carriage 630 is translated by a shift disk 617 which rides along the axle sleeve 621. The shift disk 617 is moved by the shift rod 618, which is translated by rotation of the lever 622 rotating about rod 619. The distal end of the shift rod 618 includes a shift nut 641 to secure at least two springs 660.

The components in the geared hub 603, 604 can be in one of 3 positions: low gear, high gear, or neutral. Depending on the alignment of the teeth of the clutches, the clutches may not travel the full linear distance when shifting into a gear. The user would interpret that as the shifter being jammed. Therefore, the shift rod 618 is not rigidly connected to the shift disk 617. The shift rod 618 has springs 660 on either side of the shift disk 617 so that the shift rod 618 can move to its intended position regardless of the position of the clutch teeth. The springs 660 push on the shift disk 617 until the clutch teeth line up in the correct orientation, at which point the springs 660 push the shift disk 617 the remaining way and the dog clutch locks into full engagement.

Mounting System

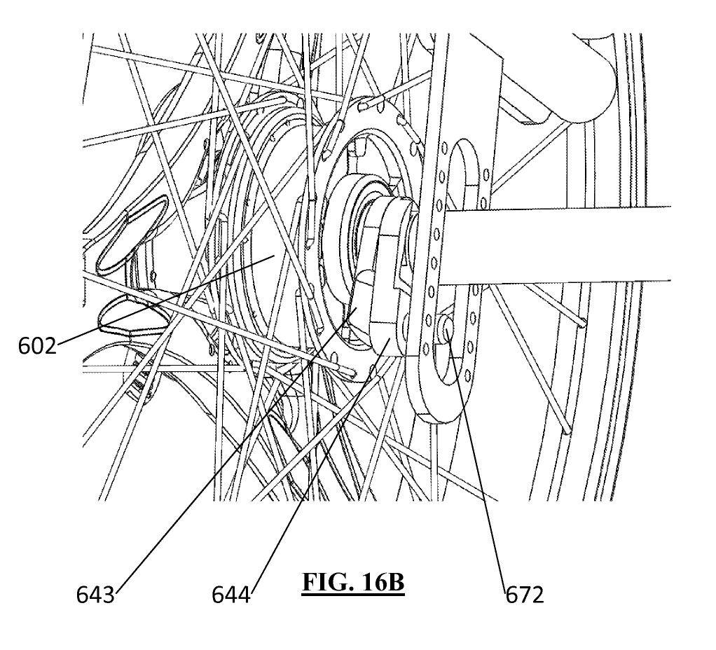

The geared wheel 601 must have its axle sleeve 621 locked from rotating in order to ensure correct operation of the gears. To accomplish this, a mounting system 631 is used is shown in FIGS. 15-16. The mounting system 631 includes a mounting plate 644 on the wheelchair side with a spring ball plunger 672. An additional mounting plate 643 connected to the axle sleeve 674 on the wheel has a spring ball plunger hole 645 which matches up to the spring ball plunger 672. When the axle 700 is inserted into the wheelchair axle sleeve 674, the spring ball plunger 672 may not be engaged with the spring ball plunger hole 645. However, once the user rotates the wheel 601 or hand rim 662, the axle sleeve 674 and the axle sleeve plate 643 will rotate about the axle 690. Small chamfers on either side of the mounting plate 644 will depress the spring ball plunger 672 until it clicks into the spring ball plunger hole 645. An alternate embodiment of this would be to have the spring ball plunger 672 on the axle plate 643 and the spring ball plunger hole 645 on the mounting plate 644.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A geared wheel system for minimizing backlash comprising:
a geared hub operably coupled to a hand rim support structure and a plurality of spokes;
the hand rim support structure operably coupled to a wheel rim and the plurality of spokes operably connected to the wheels; and
wherein the geared wheels are shifted from a direct drive transmission to a low gear drive transmission by a lever operably coupled on the outside of each hub.

2. The geared wheel system of claim 1, wherein the lever is rotated at least 140 degrees.

3. The geared wheel system of claim 2, further comprising a custom mounting system that does not require the user to line a secondary axle by rotating a wheel.

4. The geared wheel system of claim 1, where the geared hub includes a hub shell; the hub shell includes a first outer axial ring and a second outer axial ring; the first and second outer axial rings include a plurality of holes disposed around the circumference of the first and second outer axial rings; wherein the plurality of holes are connected to the plurality of spokes; the geared hub includes an input disk disposed axially over the first outer axial ring; the input disk includes a plurality of flanges disposed around the circumference of the input disk and the plurality of flanges include a distal end; and the distal end of the plurality of flanges include a plurality of openings as to be fixedly attached the hand rim support structure; wherein the hub shell operates as the output of the transmission, and the input disk operates as the input of the transmission.

5. The geared wheel system of claim 4, wherein the hand rim support structure transmits torque and rotation from a hand rim to the input disk of the geared hub; the hand rim support structure comprises a plurality of radially extending hollow tubes operably coupled with a molding; the molding surrounds the plurality of radially extending hollow tubes; and the shape of the plurality of tubes is substantially curved at an angle between about 10 and 85 degrees; and the middle portions of the plurality of tubes and the molding includes at least two openings fixedly attached to the input disk.

6. The geared wheel system of claim 5, wherein the lever rotates in a track and includes at least two flats; the at least two flats are mechanical detents to hold the lever in direct drive transmission and a low gear drive transmission; the lever includes at least two track features and a secondary slot that line up with a shift rod extending through a round portion of the shift lever; wherein the combination of the secondary slot and the track transmits the rotational motion of the shift lever into linear motion of the shift rod.

7. The geared wheel system of claim 6, wherein the geared hub includes a planetary gear set; the planetary gear set operably coupled to a shifter carriage to allow the gear box to move between gears; the shifter carriage comprises a gear carrier, a ring gear, a first dog clutch connected to the gear carrier, a second dog clutch that carries the planetary gear set, and at least two gear keepers to link the ring gear to the dog clutch while allowing independent rotation; a plurality of bushings attached to the gear carrier through the first dog clutch; and the geared hub includes a sun gear that is always locked to an axle sleeve and does not move axially or rotate.

8. The geared wheel system of claim 7, wherein the shifter carriage rides axially along a plurality of dowel pins extending from the input disk; wherein the dowel pins provide minimal backlash in the rotational direction while allowing the shifter carriage to move axially inside the geared hub; and the plurality of bushings include a size larger than the plurality of dowel pins in order to minimize backlash while still allowing smooth movement.

9. The geared wheel system of claim 8, wherein the shifter carriage moves from a neutral transmission to the direct drive transmission and the first dog clutch connected to the gear carrier engages with a third dog clutch connected to the hub shell, which makes the flow of torque to go from the input disk, into the plurality of dowel pins, into the gear carrier, into the first and third dog clutches and out through the hub shell at a 1:1 gear ratio.

10. The geared wheel system of claim 9, wherein the shifter carriage moves a neutral transmission to a low gear transmission and the second dog clutch on the shifter carriage engages with a fourth dog clutch that is connected to the hub shell, which makes the flow of torque go from the input disk, into the plurality of dowel pins, into the gear carrier, into the second dog clutch at 1.5:1 gear ratio, into the fourth dog clutch, and out through the hub shell.

11. The geared wheel system of claim 10, wherein the shifter carriage is in the neutral transmission and no dog clutches are engaged.

12. The geared wheel system of claim 7, wherein the planetary gear system is connected to the gear carrier, and locks the ring gear rotationally to the second dog clutch; wherein the geared hub can be in direct drive or high gear transmission of a 1:1.5 gear ratio.

13. The geared wheel system of claim 7, wherein the geared hub is always in low gear and cannot be shifted; wherein torque flows from the input disk, into the gear carrier, into the ring gear; the ring gear turns the planetary gear set at a 1.5:1 ratio due to the sun gear locked to the axle sleeve; and the planetary gear set is operably coupled with the plurality of dowel pins pressed into the hub shell, such that the hub shell is turned at a 1.5:1 ratio from the input disk.

14. The geared wheel system of claim 10, wherein the dog clutches include a clearance between about 0.002 and 0.015 inches and a plurality of teeth and plurality of slots; wherein the gap between each tooth is at least 0.5 degrees and corresponding slot.

15. The geared wheel system of claim 14, wherein the shifter carriage is translated by a shift disk that rides along the axle sleeve; the shift disk is moved by the shift rod, which is translated by rotation of the lever rotating about shift rod; and a distal end of the shift rod includes a shift nut to secure at least two springs.

16. The geared wheel system of claim 15, wherein the shift rod is not rigidly connected to the shift disk; and the at least two springs on either side of the shift disk allow the shift rod to move to its intended position regardless of the position of the plurality of teeth of the dog clutches; and the at least two springs push on the shift disk until the plurality of teeth of the dog clutches line up in the correct orientation, at which point the at least two springs push the shift disk and the dog clutches lock into full engagement.

17. The geared wheel system of claim 16, wherein the axle sleeve is locked from rotating in order to ensure correct operation of the gears by a mounting system; the mounting system includes a first mounting plate operably coupled with a spring ball plunger, a second mounting plate connected to the axle sleeve on the wheel, wherein the second mounting plate includes a spring ball plunger hole which mates to the spring ball plunger; wherein the spring ball plunger is not be engaged with the spring ball plunger hole when the axle is inserted into the wheelchair axle sleeve; wherein the axle sleeve and the axle sleeve plate rotate about the axle once the user rotates the wheel or hand rim.

18. The geared wheel system of claim 17, wherein the first mounting plate includes a plurality of chamfers on either side of the first mounting plate as to depress the spring ball plunger until the spring ball plunger clicks into the spring ball plunger hole.
